(19) United States
(12) Patent Application Publication
(10) Pub. No.: US 2002/0040440 A1
(43) Pub. Date: Apr. 4, 2002

(54) Data management system, data management device, and data management method

(76) Inventors: Nobuo Hashimoto, Ashiya-Shi (JP); Hideki Takewa, Osaka (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/963,408

(22) Filed: Sep. 27, 2001

(30) Foreign Application Priority Data
Sep. 29, 2000 (JP) 2000-299691

(51) Int. Cl. G06F 12/14

(52) U.S. Cl. 713/200

(57) ABSTRACT

A management system comprises a holding device for holding data, processing device for executing specific processing of data stored by the holding device, and storage device for receiving and storing data from the processing device, wherein the holding device is provided with a first transceiver for communication with the processing device, data memory for storing data, and ID information memory for storing ID information identifying the holding device, and wherein the processing device is provided with a second transceiver for communication with the holding device, and a processor for reading data from the data memory through the second transceiver and classifying the data based on the ID information, and wherein the storage device stores data classified by the processor of the processing device and its corresponding ID information.

This application is based on Patent Application No. 2000-299691 filed in Japan, the content of which is hereby incorporated by reference.

### BACKGROUND OF THE INVENTION

1. Field of the Invention

The present invention relates to art for saving data, and art for accessing saved data.

2. Description of the Related Art

Generally, a terminal is installed in order to use a data management device, and this terminal is used jointly by a plurality of users. Alternatively, a plurality of terminals for a plurality of users may be connected to a single data management device. When a terminal is used to save data to the data management device or access saved data, each user is required to input an individual ID (account) and password from the data management device. The individual ID and password is required for security purposes, and a registered user is verified by inputting the correct ID and password, and given authority to use the terminal as a normal user.

The ID and password are unique means specifically set for each user of the data management device. Accordingly, the input of the ID and password cannot be omitted, and the input must be without errors. From the user point of view, this identical operation must be performed each time, and is complicated. Furthermore, when a user forgets an ID or password, access to the data management device is denied. When the ID and password is stolen by another person, this other person can delete or modify data, and cause immeasurable damage.

### SUMMARY OF THE INVENTION

An object of the present invention is to allow saving of data and access to saved data while maintaining security without inputting an ID and password.

The management system of the present invention comprises a holding device for holding data, processing device for executing specific processing of data stored by the holding device, and storage device for receiving and storing data from the processing device, wherein the holding device is provided with a first transceiver for communication with the processing device, data memory for storing data, and ID information memory for storing ID information identifying the holding device, and wherein the processing device is provided with a second transceiver for communication with the holding device, and a processor for reading data from the data memory through the second transceiver and classifying the data based on the ID information, and wherein the storage device stores data classified by the processor of the processing device and its corresponding ID information.

The processor of the processing device also may access data stored in the storage device based on ID information read from the data memory of the holding device through the second transceiver.

The holding device also may be a digital camera for photographing an object and generating and storing digital image data.

The storage device also may be provided within the processing device.

The processing device also may be provided with a printing mechanism for printing data read from the storage device after the read data are subjected to specific processing based on ID information read from the data memory of the holding device.

The processing device and the storage device also may be connected to a communication network, such that data can be transmitted over the communication network.

The ID information also may be a unique identification number identifying the holding device.

The processor of the processing device also may allocate a memory area of the storage device to each unique identification number, and the storage device may store data in the corresponding memory area in accordance with the unique identification number.

The image management device of the present invention comprises an image processor for receiving and specifically processing the image data from an image data holding device for holding image data, and a memory for receiving and storing image data from the image processor, wherein the image processor is provided with a transceiving means for communication with the image data holding device, and a classification processing means for reading image data from the image data holding device through the transceiving means and classifying the image data based on ID information identifying the image data holding device, and wherein the memory stores image data classified by the classification processing means corresponding to the ID information.

The image management method of the present invention comprises a step of receiving and specifically processing the image data from the image data holding device for holding image data, and a step of receiving and storing the processed image data, wherein the step of processing comprises a step of communicating with the image data holding device, and a step of reading image data from the image data holding device via the communication step, and classifying the image data based on ID information identifying the image data holding device, and wherein the step of storing comprises a step for storing image data classified in the classification step corresponding to the ID information.

The memory medium of the present invention stores a computer program for executing management comprising a step of receiving and specifically processing the image data from the image data holding device for holding image data, and a step of receiving and storing the processed image data, wherein the step of processing comprises a step of communicating with the image data holding device, and a step of reading image data from the image data holding device via the communication step, and classifying the image data based on ID information identifying the image data holding device, and wherein the step of storing comprises a step for storing image data classified in the classification step corresponding to the ID information.

These and other objects, advantages and features of the invention will become apparent from the following description thereof taken in conjunction with the accompanying drawings which illustrate specific embodiments of the invention.

### BRIEF DESCRIPTION OF THE DRAWINGS

In the following description, like parts are designated by like reference numbers throughout the several drawings.

FIG. 1 shows the image management system of the present invention.

FIG. 2 shows the structure of the data processing device and the digital camera of the image management system.

FIG. 3 shows the logic structure of the storage device.

FIG. 4 is a flow chart showing the image data saving process.

FIG. 5 is a flow chart showing the image data examination process.

FIG. 6 shows a second image management system.

FIG. 7 shows the printing mechanism of the data processing device in the image management system.

FIG. 8 shows the image management system connected to a communication network.

### DESCRIPTION OF THE PREFERRED EMBODIMENTS

The embodiments of the present invention are described hereinafter with reference to the accompanying drawings. In the embodiments of the present invention, acquired data is described as image data.

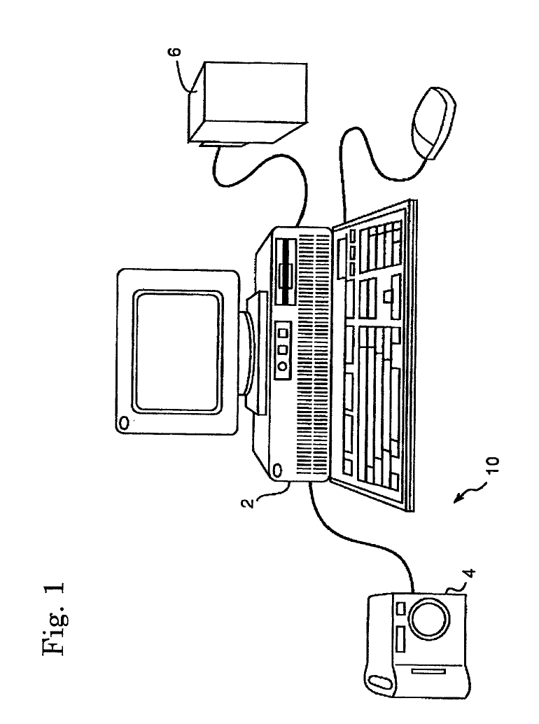

FIG. 1 shows an image management system 10 of the present invention. The image management system 10 includes a data processing device 2, digital camera 4, and storage device 6. In the image management system 10, image data generated by photography using the digital camera 4 are classified by the data processing device 2 based on unique information in the digital camera 4, and stored in the storage device 6 in accordance with the classification. The image processing device 2 of the image management system 10 is a device for executing data processing, i.e., a personal computer or the like. Since the essential processing of the present invention is executed by the data processing device 2, the data processing device 2 may also be called an image management device. The digital camera 4 is a so-called image sensing device. The storage device 6 is a well-known storage device such as a hard disk, CD-ROM drive, tape streamer or the like provided externally to the data processing device 2. The storage device 6 need not be independently provided externally, and may be provided in a slot within the data processing device 2.

A main characteristic of the image processing system 10 is that when a digital camera 4 is connected to the data processing device 2, the data processing device 2 saves image data based on ID information identifying the digital camera 4 stored in the memory of the digital camera 4. “Based on ID information” in this case means image data are saved based on ID information, in units of each individual digital camera 4 which has unique ID information. Since image data are saved “based on ID information,” it is unnecessary for a user to input an ID and password.

Furthermore, when a certain digital camera 4 is connected, image data of another digital camera having different ID information cannot be freely accessed. Accordingly, security is maintained. Considering that a specific user [a] normally uses a certain digital camera A (e.g., the owner of a digital camera A), the user [a] can be expected to request access when the digital camera A is connected. Accordingly, the image management system 10 can be said to essentially manage data for “each user” by saving image data “based on ID information.” When a user

lends the digital camera A to a user [b], or when a user [b] steals the digital camera A, the user [b] may request access to the digital processing device 2, however, user [b] is denied access to image data owned by users other than user [a] because image data are managed in units of the individual digital camera, providing effective security.

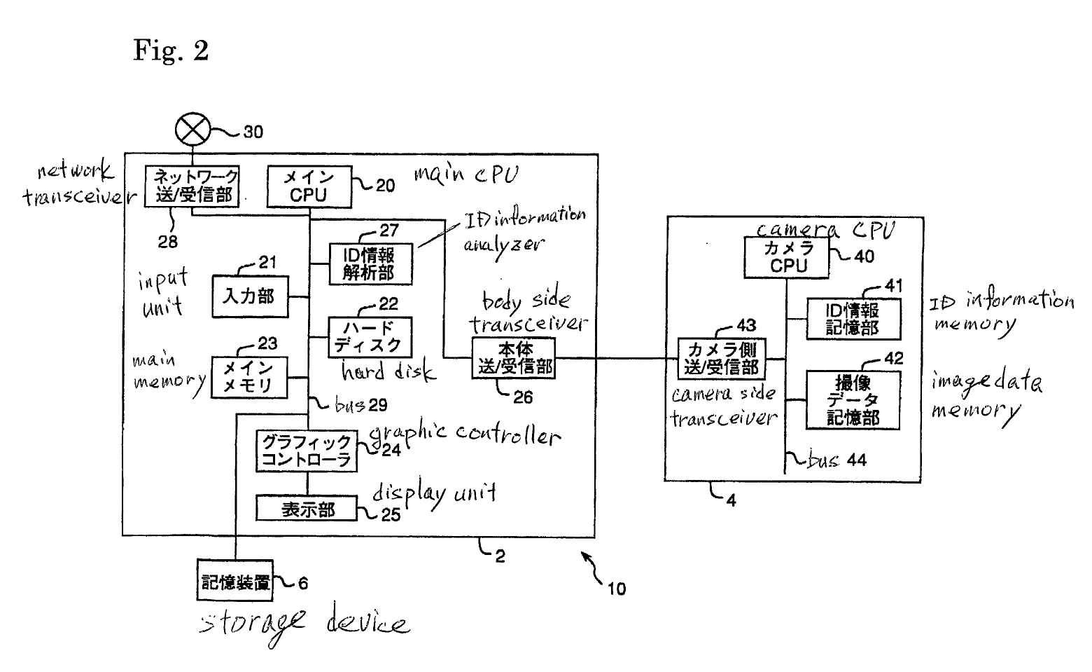

The image management system 10 is described more specifically with reference to FIG. 2. FIG. 2 shows the structure of the data processing device 2 and digital camera 4 of the image management system 10. First, the structure of the data processing device 2 and digital camera 4, and the storage device 6 are described below, and thereafter the operation of the image management system 10 is discussed.

The data processing device 2 includes a main CPU 20, input unit 21, hard disk 22, main memory 23, graphic controller 24, display unit 25, body side transceiver 26, ID information analyzer 27, network transceiver 28, and bus 29 connecting these structural elements to allow data to be sent and received among these structural elements.

The main CPU 20 is a processing device which performs the general processing of the data processing device. For example, the main CPU 20 executes computer programs for the processing of the present invention, and suitably controls the operation of each structural element. When the result of analysis of ID information of the digital camera 4 described later indicates a save group of image data corresponding to the ID information exists, the main CPU 20 classifies the image data acquired by the digital camera 4 as being associated with the save group, and stores the image data in the storage device 6.

The input unit 21 is a mechanism allowing a user to input specifications and data to the data processing device 2. For example, the input unit 21 may be a keyboard, mouse or the like. A user can specify saving, examination, display, and printing of image data from the input unit 21. The hard disk 22 has sufficient data storage capacity for storing an operating system (OS) program for controlling the operation of the data processing device 2, and application programs (e.g., computer programs for executing the processing of the present invention) operating on the OS. When the hard disk 22 also functions as a holding device 6, the hard disk 22 is used to store image data input by a user.

The main memory 23 is used for executing programs or processing by the main CPU 20, e.g., execution of image processing applications, and developing image data being processed by the image processing application. The processing in the present embodiment is executed based on a step for executing a computer program (software) stored in the main memory 23. The computer program also may be part of the OS, for example, or an application program operating on the OS. The graphic controller 24 executes processing for displaying an image resulting from the processing of the main CPU 20 on the display unit 25. For example, when the display unit 25 is a well-known monitor, data processing can be executed using the color of the pixels of the monitor. The display unit 25 is a well-known display device such as a monitor for displaying the results of processing by the main CPU 20. Although the display unit 25 has been described as a structural element of the data processing device 2, it also may be a display device separate from the data processing device 2.

The body side transceiver 26 is connected to the digital camera 4, and is a communication interface for receiving data from the digital camera 4. For example, when the data processing device 2 and the digital camera 4 communicate using a USB (universal serial bus), the body side transceiver 26 may be a USB host controller or the like, or may be a well-known radio transceiver mechanism in the case of wireless communication. Data received from the digital camera 4 is, for example, image data. The body side transceiver 26 receives ID information stored in the digital camera 4 identifying the digital camera 4. When the data processing device 2 receives information from the digital camera 4, all such information is received through the body side transceiver 26; hereinafter, the transmission of information through the body side transceiver 26 is not particularly expressed.

The ID information analyzer 27 analyzes the ID information read from the digital camera 4 through the body side transceiver 26. The analysis specifically confirms the existence/absence of ID information, and acquires the ID information when it exists. The analysis operation of the ID information analyzer 27 also may be executed by the main CPU 20. The network transceiver 28 is an interface for communication and sending/receiving data when the data processing device 2 is connected to another data processing device or server over the communication network 30. Although image data may be stored in the storage device 6 in the image management system 10, image data also may be stored on an image database server. In this case, the network transceiver 28 sends image data to the communication network 30.

The structure of the digital camera 4 is described below. The digital camera 4 is a well-known image sensing device which photographs an object and generates image data. The digital camera 4 is capable of preserving image data of at least one or more generated image. The digital camera 4 includes a camera CPU 40, ID information memory 41, image data memory 42, camera side transceiver 43, and bus 44 connecting all these structural elements for sending and receiving image data among the structural elements.

The camera CPU 40 is a processing device for executing all processing in the digital camera 4. For example, during photography the camera CPU 40 generates sensed image data (image data) of a specific number of pixels and colors that can be displayed, and saves the sensed image data. When connected to the data processing device 2, the camera CPU 40 receives requests sent from the image processing device 2, and sends a specific response to the image processing device 2.

The ID information memory 41 is an electrically erasable program ROM (EEPROM) or the like. The ID information memory 41 stores ID information unique to the digital camera 4, which makes the digital camera 4 identifiable. The ID information may be, for example, the manufacturers name of the digital camera 4, product name, serial number, manufacture license number or the like.

The image data memory 42 may be a semiconductor memory such as RAM or the like, magnetic recording medium such as a floppy disk, hard disk or the like, or optical storage medium such as a DVD or the like. The image data memory 42 stores image data generated by the camera CPU 40, and reads the image data whenever required if image data transfer is requested.

The camera side transceiver 43 is a mechanism for sending and receiving data to the data processing device 2. When the digital camera 4 receives a request for information from the data processing device 2, all data are send through the camera side transceiver 43, therefore, in the following description the transmission of data through the camera side transceiver 43 is not particularly expressed similar to the body side transceiver 26.

Other structures of the digital camera 4 not shown in the drawings include a ROM for storing programs for controlling the operation of the digital camera 4. Furthermore, photographed images are displayed on a liquid crystal display also not shown in the drawings.

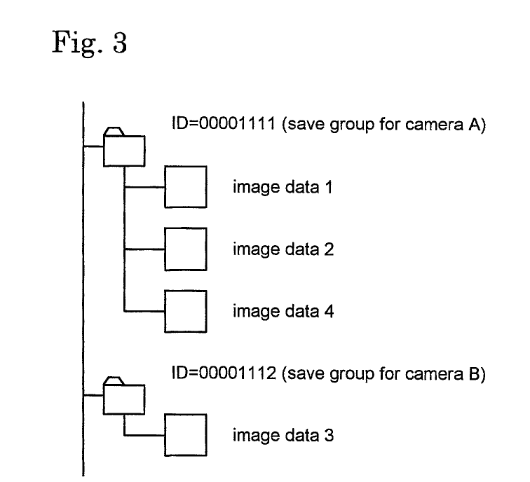

Finally, the storage device 6 is a well-known storage device such as and external hard disk, DVD-ROM drive, tape streamer or the like provided outside the data processing device 2 as previously mentioned. The storage device 6 stores image data classified by the main CPU 20 of the data processing device 2. FIG. 3 shows the logic structure of the storage device 6 (FIG. 2). The storage device 6 (FIG. 2) allocates memory area for each ID information, and stores image data in the corresponding memory area in accordance with the ID information. In the example of FIG. 3, image data are classified and stored in special save groups in accordance with the ID information of the digital cameras A and B. Each save group has a respectively different ID number. The ID number, for example, is a manufacture number among the ID information of the digital camera. In FIG. 3, although only digital cameras A and B are classified, more classifications may be created in accordance with the number of connected digital cameras. FIG. 3 shows the logic structure of the data processing device 6 (FIG. 2); when actually storing data in the data processing device 6, the ID information is appended to the image data and the image data are stored. When displaying image data in the save group, the image data having that ID information are examined.

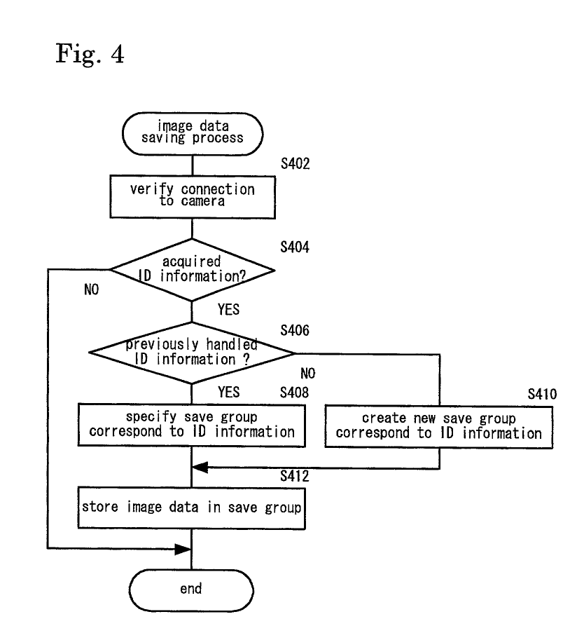

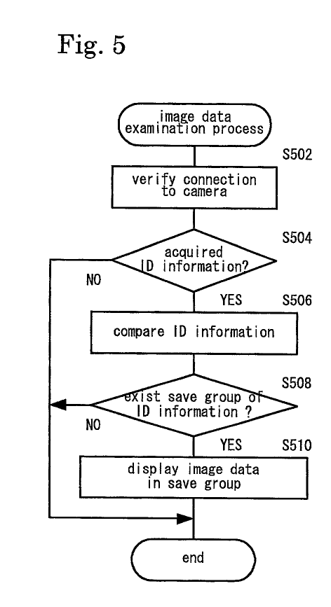

The operation of the image management system 10 having the aforesaid structure is described below. Two types of operation are described: (1) the operation of saving image data (FIG. 4), and (2) the operation of examining image data (FIG. 5).

1) Image Data Saving Operation

FIG. 4 is a flow chart showing the image data saving process. First, the main CPU 20 (FIG. 20) of the data processing device 2 verifies that a digital camera 4 (FIG. 2) is connected (step S402). At this time, a user uses the input unit 21 (FIG. 2) to switch to the save mode by specifying the image data save process in an operation described later. When connection is verified, the main CPU 20 (FIG. 2) starts reading the ID information memory 41 (FIG. 2) of the digital camera 4 (FIG. 2) through the body side transceiver 26 (FIG. 2). The ID information analyzer 27 (FIG. 2) of the data processing device 2 (FIG. 2) determines whether or not ID information can be acquired (step S404). When ID information cannot be acquired (step S404: NO), processing ends in the present invention. In this case, the user may save image data using another method, e.g., input an ID and password as in conventional methods.

When ID information can be acquired (step S404: YES), the ID information analyzer 27 (FIG. 2) determines whether or not the ID information matches previously handled ID information (step S406). This operation determines whether or not the acquired ID information matches an ID (FIG. 3) appended to a save group classified in the storage device 6 (FIG. 2). For example, when the acquired ID information is [ID=00001112], it is identical to the ID of the special save group of the digital camera B shown in FIG. 3. This ID information is determined to be previously handled ID information. On the other hand, when the acquired ID information is [ID=00001115], this ID information is determined to not be previously handled ID information because it differs from the ID information of the save groups shown in FIG. 3. Since time is required to examine the ID information of all save groups, an ID table appended to the classified save groups may be provided in the hard disk 22 (FIG. 2), or storage device 6 (FIG. 2).

When the determination result is that ID information matches previously handled ID information (step S406: YES), the main CPU 20 (FIG. 2) specifies a save group corresponding to the ID information based on the acquired ID information (step S408). For example, when the acquired ID information is [ID=00001112] as in the above example, the special save group of the digital camera B shown in FIG. 3 is specified. Then, the main CPU 20 sends image data stored in the image data memory 42 (FIG. 2) of the digital camera 4 (FIG. 2) through the body side transceiver 26 (FIG. 2), and stores the image data in the associated save group in the storage device 6 (FIG. 2).

On the other hand, when the determination result is that the ID information does not match previously handled ID information (step S406: NO), no classification exists yet for this digital camera 4 (FIG. 2) in the storage device 6 (FIG. 2) because this can be said to be the first use of the digital camera 4 (FIG. 2). At this time, a new save group corresponding to the ID information is created in the storage device 6 (FIG. 2) (step S410). If necessary, the user may be alerted to the creation of a new save group, and the permission of the user sought. The ID information is appended to the new save group. Thereafter, the main CPU 20 (FIG. 2) saves the image data stored in the image data memory 42 (FIG. 2) in the save group created in the storage device 6 (FIG. 2) in the same way as described above (step S412). Then, the image data save operation ends.

(2) Image Data Examination Operation

FIG. 5 is a flow chart showing the image data examination process. This process indexes the ID information of the digital camera 4 (FIG. 2), specifies the save group in the storage device 6 (FIG. 2), and examines and displays only image data included in the save group from among all image data. First, the main CPU 20 (FIG. 2) of the data processing device 2 (FIG. 2) verifies that a digital camera 4 (FIG. 2) is connected (step S502). At this time the user uses the input unit 21 (FIG. 2) to switch to the examination mode by to specify the operation described later of the image data examination process. When connection is verified, the main CPU 20 (FIG. 2) starts reading the ID information memory 41 (FIG. 2) of the digital camera 4 (FIG. 2) through the main side transceiver 26 (FIG. 2). The ID information analyzer 27 (FIG. 2) of the data processing device 2 (FIG. 2) determines whether or not the ID information can be acquired (step S504). When ID information cannot be acquired (step S504: NO), processing ends in the present invention. In this case, the user may save image data using another method, e.g., input an ID and password as in conventional methods.

When ID information can be acquired (step S504: YES), the ID information analyzer 27 (FIG. 2) compares the acquired ID information to ID information corresponding to save groups on the storage device 6 (FIG. 2) (step S506), and determines whether or not a save group exists which corresponds to the acquired ID information (step S508). When a corresponding save group exists (step S508: YES), the image data associated with this save group are displayed at a suitable number sequentially from the oldest data or from the newest data (step S510). The display also may display only all file names of the image data, or may display the display images compressed from the image data. A user can execute processing such as printing needed image data or editing from among displayed image data. As previously mentioned in the description of the storage device 6 (FIG. 2), only the image data with appended ID information are actually stored in the storage device 6 (FIG. 2). Accordingly, when displaying image data associated with a save group, the image data having this ID information in the storage device 6 (FIG. 2) must be examined.

On the other hand, when a save group corresponding to the acquired ID information does not exist (step S508: NO), the process ends. Image data photographed by that digital camera 4 (FIG. 2) are not saved in the storage device 6 (FIG. 2).

The image data save operation and image data examination operation have been described above.

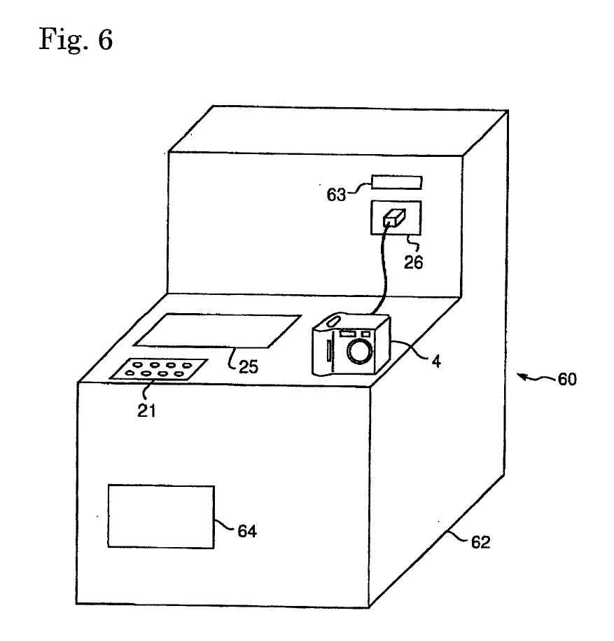

Another example of the image management system 10 is described below. FIG. 6 shows a second image management system 60. The image management system 60 differs from the image management system 10 in that a coin vending type data processing device 62 is used rather than the data processing device 6. When a user inserts a specific fee, the data processing device 62 prints image data from a digital camera 4 connected to the body side transceiver 26 and ejects the print from a print discharge port 64.

The structure of the data processing device 62 is completely identical with that of the data processing device 6 (FIG. 2) with the exception that the mechanism for printing and internal storage device 6 (FIG. 2) are omitted. Accordingly, the data processing device 62 performs the exact same operation as the data processing device 2 (FIG. 2) referring to FIGS. 4 and 5. That is, when a digital camera 4 is connected, the ID information of the digital camera 4 is read. When the ID information exists already, image data are saved to the save group created based on the ID information, or image data associated with the save group are examined based on the ID information, and displayed on the display unit 21. The user suitably selects image data through the input unit 21, and specifies printing.

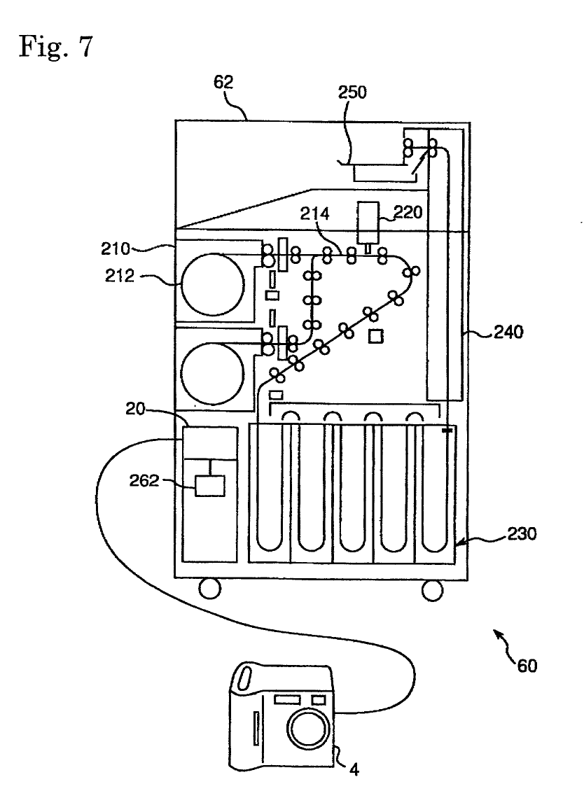

The structure of the data processing device 62 is described below. In the structure of the data processing device 62, only the printing mechanism which differs from the data processing device 2 (FIG. 2) is described. FIG. 7 shows the printing mechanism of the data processing device 62 in the image management system 60. The printing mechanism of the data processing device 62 includes printing paper 212 stored in a paper magazine 210, exposure unit 220 for optically exposing the printing paper 212, developing unit 230 for developing the printing paper 212, drying unit 240 for drying the printing paper 212, and output tray 250 for outputting the printed printing speed 212. These structural elements are arranged at the starting end and terminal end of the transport path 214 of the printing paper, and intermediately along the transport path 214. The transport path 214 is a transport path for the printing paper 212 formed by a plurality of rollers. An image output device 100 further includes a controller 260 for controlling all operation of the image output device 100 such as processing data received from the digital camera 4, printing an image on printing paper and the like, and a storage device 262. The storage device 262 is equivalent to the storage device 6 (FIG. 2).

The operation of the printing mechanism of the data processing device 62 is briefly described below. First, the controller 260 of the image output device 100 pulls the printing paper 212 along the transport path 214, and cuts the printing paper to a required length. The controller 260 optically exposes the cut printing paper 212 via the exposure unit 220 based on the image data signal processed for printing. The controller 260 transports the exposed printing sheet, which is subjected to a developing process, fixing process, and stabilizing process in the developing unit 230. Thereafter, the printing sheet is dried in the drying unit 240. The controller 260 ejects the developed and dried printing paper 212 to the output tray 250 as a print. The output tray 250 is internally connected to the discharge port 64 (FIG. 6), the print is ejected from the discharge port 64 (FIG. 6). The provision of this print controller allows the data processing device 62 to print saved image data at any time. The second image management system 60 has been described above.

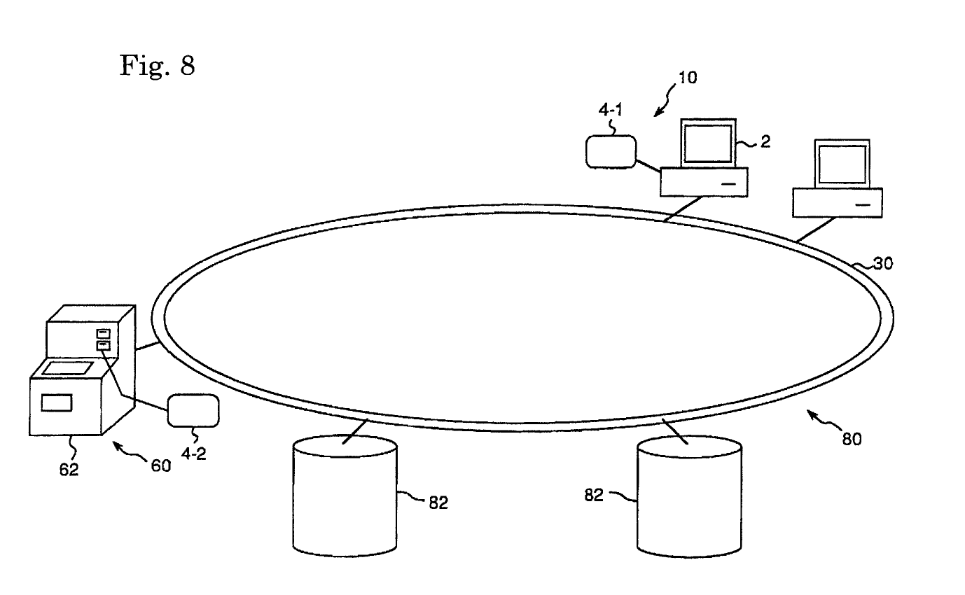

An example of the structure of an image management system using a communication network is described below. FIG. 8 shows an image management system connected to a communication network 30. The communication network 30 is, for example, the internet. When a data processing device is connected to the communication network 30, various types of image data management can be performed. Since image data management can be performed by the data processing devices 2 and 62 and digital cameras 4-1, 4-2 of the image management systems 10 and 60, image data management is similar to that already described up to this point.

On the other hand, image data of the digital cameras 4-1 and 4-2 may be saved on a database server 82 through the communication network 30 without being saved in the data processing devices 2 and 62 or their respective storage devices (not shown in FIG. 8). In this case the data processing devices 2 and 62 operate to create a classification of a save group on the database server 82 based on the ID information of the digital camera 4-1, and image data from the digital camera 4-1 are transmitted to the database server 82. The database server 82 itself also may create a classification of a save group based on the ID information of the digital camera 4-1, and save the image data. Since image data can be saved and examined from the data processing device by saving image data on the database server 82 insofar as the data processing device is connected to the communication network 30, a user can easily access image data and manage batched image data. A user can save image data even when the data processing device used by the user does not have sufficient capacity to save the image data on the data processing device. Additionally, the image data of the digital camera 4-1 also may be saved in the data processing device 62 for high quality printing.

The embodiments of the present invention have been described above. In these embodiments, the ID information of a digital camera has been described as information stored on an electrically readable EEPROM or the like. However, the ID information also may be magnetically readable information. In this case, the ID information is recorded on magnetic recording medium provided outside the digital camera rather than recorded on ROM or the like. The ID information can be read by a magnetic scanner provided in the data processing unit. Furthermore, the ID information also may be optically readable bar code. The bar code may also be displayed outside the digital camera. In this case also, the ID information can be read by a bar code reader provided in the data processing device. In these instances, the ID information is not transmitted through the camera side transceiver 43 (FIG. 2) of the digital camera 4 (FIG. 2), and only image data are transmitted. A password also may be used to ensure security.

The embodiments of the present invention have described managing image data from a digital camera 4 (FIG. 2), however, image data are not limited to a digital camera. Insofar as ID information can be appended, image data may be stored on image data storage media, and image data holding devices such as, for example, recording media typified by compact flash, smart media and the like. Image recording media may be inserted, for example, in the media slot 63 (FIG. 6), to provide ID information and image data to the data processing device 62 (FIG. 6).

The operation of the image management systems 10 (FIG. 1) and 60 (FIG. 6) described in the embodiments of the present invention is accomplished by executing computer programs regulating such processes. For example, in the data processing device 2 (FIG. 2), the main CPU 20 (FIG. 2) interprets and executes such a computer program. The computer program may be recorded on an optical disk such as CD-ROM, DVD or the like, and magnetic recording media such as floppy disk, hard disk and the like, and may be transmitted to another computer over a telephone communication line such as the internet, and recorded on a recording medium such as memory on the remote computer.

The above embodiments have described examples using image data, however, the data also may be music data, numeric data obtained by measurement, program data and the like. When handling music data, a sound recorder may be used rather than a digital camera.

According to the present invention, data are classified based on ID information, and a user is not required to input an ID or password to save or examine data, thereby improving operation characteristics. Furthermore, security is ensured because data cannot be saved or examined (data access) based on different ID information. If ID information is appended to a data holding device, access cannot be denied because a password has been forgotten.

Since data can be transmitted and recorded using a communicaiton network, a user can save data and batch manage data even when the data processing device used by the user has insufficient capacity to save the data.

Although preferred embodiments of the invention have been described in the foregoing detailed description and illustrated in the accompanying drawings, it will be understood that the invention is not limited to the embodiments disclosed, but is capable of numerous rearrangements, modifications and substitutions of parts and elements without departing from the spirit of the invention. Accordingly, the present invention is intended to encompass such rearrangements, modification and substitutions of parts and elements as fall within the spirit and scope of the invention.

What is claimed is:

1. A management system comprising:
a holding device which holds data;
a processing device which execute specific processing of data held by the holding device; and
a storage device which receives and stores data from the processing device,
wherein the holding device is provided with a first transceiver for communication with the processing device, data memory for storing data, and ID information memory for storing ID information identifying the holding device, and wherein the processing device is provided with a second transceiver for communication with the holding device, and a processor for reading data from the data memory through the second transceiver and classifying the data based on the ID information, and wherein the storage device stores data classified by the processor of the processing device and its corresponding ID information.

2. A management system according to claim 1, wherein said processor of the processing device accesses data stored in the storage device based on ID information read from the data memory of the holding device through the second transceiver.

3. A management system according to claim 1, wherein said holding device is a digital camera which photographs an object and generates and stores digital image data.

4. A management system according to claim 1, wherein said storage device is provided within the processing device.

5. A management system according to claim 1, wherein said processing device is provided with a printing mechanism for printing data read from the storage device.

6. A management system according to claim 5, wherein said printing mechanism print data after the read data are subjected to specific processing based on ID information read from the data memory of the holding device.

7. A management system according to claim 1, wherein said processing device and said storage device are connected to a communication network.

8. A management system according to claim 1, wherein said ID information is a unique identification number identifying the holding device.

9. A management system according to claim 1, wherein said processor of the processing device allocates a memory area of the storage device to each unique identification number, and said storage device stores data in the corresponding memory area in accordance with the unique identification number.

10. A data management device comprising:
a data processor which receives and processes data from a data holding device; and
a memory for stores data received the data processor,
wherein the data processor is provided with a transceiving unit for communication with the data holding device, and a classification processing means for reading data from the data holding device through the transceiving means and classifying the data based on ID information identifying the data holding device, and wherein the memory stores data classified by the classification processing means corresponding to the ID information.

11. A data management method comprising the steps of:
communicating with data holding device and identifying ID information of the data holding device;
classifying data received from the data holding device based on the ID information; and
storing data classified in the classification step corresponding to the ID information.

12. A recording medium which stores a computer program for executing management comprising a step of:
communicating with data holding device and identifying ID information of the data holding device;
classifying data received from the data holding device based on the ID information; and
storing data classified in the classification step corresponding to the ID information.
